(19) United States
(12) Patent Application Publication
(10) Pub. No.: US 2022/0032551 A1
(43) Pub. Date: Feb. 3, 2022

(54) LABEL PROPERTY SELECTION BASED ON PART FORMATION CHARACTERISTICS

(71) Applicant: Hewlett-Packard Development Company, L.P., Spring, TX (US)

(72) Inventors: Ji Won Jun, Palo Alto, CA (US); Crang Peter Sayers, Palo Alto, CA (US); Artur Pereira Sampaio, Palo Alto, CA (US); Prakash Reddy, Palo Alto, CA (US); Luis Baldez, Vancouer, WA (US)

(73) Assignee: Hewlett-Packard Development Company, L.P., Spring, TX (US)

(21) Appl. No.: 17/297,651

(22) PCT Filed: Apr. 25, 2019
(86) PCT No.: PCT/US2019/029057

§ 371 Date: May 27, 2021

(51) Int. Cl. B29C 64/393; B29C 64/165; B33Y 10/00; B33Y 30/00; B33Y 40/20; B33Y 50/02

(52) U.S. Cl. CPC B29C 64/393; B29C 64/165; B33Y 50/02; B33Y 30/00; B33Y 40/20; B33Y 10/00

(57) ABSTRACT

In one example in accordance with the present disclosure, a system is described. The system includes a property determiner to determine visual properties of a part to be formed. A formation determiner of the system determines characteristics of a formation of the part and a label to be disposed thereon. The system also includes a label generator to select label properties based on the visual properties of the part and the characteristics of the formation of the part and label. The system also includes a controller that controls formation of the label on the part.

### BACKGROUND

Product labels are placed on manufactured products to communicate a wide variety of information. For example, a product label may provide information about the part and/or the producer of the part. In some examples, the label may be intended to communicate information to a consumer of the part. The product label may also be intended to communicate information to an operator of a downstream manufacturing station.

### BRIEF DESCRIPTION OF THE DRAWINGS

The accompanying drawings illustrate various examples of the principles described herein and are part of the specification. The illustrated examples are given merely for illustration, and do not limit the scope of the claims.

FIG. 1 is a block diagram of a system for selecting label properties based on part formation characteristics, according to an example of the principles described herein.

FIG. 2 is a flow chart of a method for selecting label properties based on part formation characteristics, according to an example of the principles described herein.

FIG. 3 is a diagram of a modeling stage during which label properties are selected, according to an example of the principles described herein.

FIG. 4 is a flow chart of a method for selecting label properties based on part formation characteristics, according to another example of the principles described herein.

FIG. 5 is a block diagram of an additive manufacturing system for selecting label properties based on part formation characteristics, according to another example of the principles described herein.

FIG. 6 is a diagram of a packing stage during which label properties are selected, according to an example of the principles described herein.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

Product labels are affixed to manufactured products to communicate a wide variety of information associated with the part. For example, information printed on the label, in either an encoded or human-readable format, may provide information to a consumer regarding the origin of the part as well as information for the part itself. For example, the label may indicate a batch number for the part, or may indicate the products conformance with certain quality standards. In other examples, the label information may be used during manufacturing of the product. For example, the label may include manufacturing instructions. In other examples, a part may have a serial number to be included on a label. In yet further examples, the part may have a description of suggested post-processing operations or details on the job, printer, material batch, and process settings used to make that part. In summary, while specific reference is made to particular label information, a product label may include a wide variety of information.

In some examples, the label may be attached to the product, in others, the label may be integrally formed on the product. For example, via a number of mechanisms, additive manufacturing systems can form three-dimensional printed parts and as part of that process, the label may be printed on the product itself.

As one specific example, an additive manufacturing system may make a three-dimensional (3D) object through the solidification of layers of a build material on a bed within the system. In this example, an additive manufacturing system may make a physical printed object based on data in a 3D model. The model data is processed into slices, each slice defining portions of a layer of build material that is to be solidified.

To form the 3D object, a build material, which may be powder, is deposited on a bed in a layer-wise fashion. A fusing agent is then dispensed onto portions of the layer of build material that are to be fused to form a layer of the 3D object. The system that carries out this type of additive manufacturing may be referred to as a powder and fusing agent-based system. The fusing agent disposed in the desired pattern increases the energy absorption of the topmost layer of build material on which the agent is disposed. The build material is then exposed to energy such as electromagnetic radiation. The electromagnetic radiation may include infrared light, laser light, or other forms of suitable electromagnetic radiation. Due to the increased energy absorption properties imparted by the fusing agent, those portions of the build material that have the fusing agent disposed thereon heat to a temperature greater than the fusing temperature for the build material.

Accordingly, as energy is applied to a surface of the build material, the build material that has received the fusing agent, and therefore has enhanced energy absorption characteristics, fuses while that portion of the build material that has not received the fusing agent remains in powder form. Those portions of the build material that receive the agent and thus have increased energy absorption properties may be referred to as fused portions. By comparison, the applied energy is not so great so as to increase the energy absorption properties of the portions of the build material that are free of the fusing agent. Those portions of the build material that do not receive the agent and thus do not have increased energy absorption properties may be referred to as unfused portions.

Accordingly, a predetermined amount of energy is applied to an entire bed of build material, the portions of the build material that receive the fusing agent, due to the increased energy absorption properties imparted by the fusing agent, fuse and form the object while the unfused portions of the build material are unaffected, i.e., not fused, in the presence of such application of energy. This process is repeated in a layer-wise fashion to generate a 3D object. That is, additional layers may be formed and the operations described above may be performed for each layer to thereby generate a three-dimensional object. Sequentially layering and fusing portions of layers of build material on top of previous layers may facilitate generation of the three-dimensional object. This process is then repeated until a complete physical object has been formed. The layer-by-layer formation of a three-dimensional object may be referred to as a layer-wise additive manufacturing process.

The unfused portions of material can then be separated from the fused portions, and the unfused portions may be recycled for subsequent 3D printing operations. While specific reference is made to one type of additive manufacturing process, the principles described herein may apply to other types of manufacturing processes. Moreover, while specific reference is made to printing a label on a 3D printed object, the subject matter of the present specification may be applied to other forms of labels attached to different types of objects.

While the use of such product labels is inarguably effective in the information they communicate, enhancements to their use may allow for more effective transmission of the label information. That is, any number of factors may affect the readability of a label. For example, in an additive manufacturing process, a surface finish of the part may change based on the orientation and process selection. The surface finish may affect the readability of an engraved or embossed label. As a specific example, a horizontal surface of a 3D printed part may have higher resolution as compared to a vertical surface of a 3D printed part due to the operation of the 3D printing process. This difference may alter the readability of the label disposed thereon.

In another example, the readability of a label may change based on when it is to be read. For example, if a label is to be read before a final dye is applied to the part, a label may be more or less readable as compared to when the final dye is applied. Other examples exist, which will be described below, where label readability is affected by characteristics of the part on which it is formed.

To address this, one option may be to choose a conservative label, i.e., very large labels, readable at any stage in the manufacturing process, when printed at any orientation, and with any surface finish. However, such large labels may not fit on smaller parts and may be functionally or aesthetically undesirable.

Accordingly, the present specification describes systems and methods for choosing label styles that are just large enough to be readable based on characteristics of the formation of the part.

As a specific example, the systems and methods described herein may determine a suitable label style, font, and/or size based on the part orientation, surface finish, and the manufacturing stage in which the label is to be read. The readability of the label is preserved as the user attempts to re-orient the part in a packing stage. For example, if when arranging digital representations of the to be printed parts in an additive manufacturing system, a user attempts to rotate the digital representation, the system may change the label properties to accommodate the different surface finish or voxel accuracy.

In some cases, the system may notify a user if a suitable label is unavailable. In other cases, if user alteration of the digital representation would result in an unsuitable label, the system may prevent such an alteration.

Specifically, the present specification describes a system. The system includes a formation determiner of the system determines characteristics of a formation of the part and a label to be disposed thereon. A label generator of the system selects label properties based on visual properties of the part and the characteristics of the formation of the part and label. Finally, a controller to control formation of the label on the part.

The present specification also describes a method. According to the method, visual properties of a three-dimensional (3D) printed part to be formed are determined as are characteristics of a formation of the 3D printed part and the label to be disposed thereon. Label properties are selected based on the visual properties of the 3D printed part and the characteristics of the formation of the 3D printed part and the label. Sequential deposition of powdered build material and a fusing agent are controlled to form the 3D printed part and the label.

The present specification also describes an additive manufacturing system. The additive manufacturing system includes a build material distributor to deposit layers of powdered build material onto a bed and an agent distributor to selectively solidify portions of layer of powdered build material to form a three-dimensional (3D) printed object and a label formed thereon. The additive manufacturing system also includes the property determiner, formation determiner, label generator, and controller as described above.

The present systems and methods 1) automatically vary the label properties based on characteristics of the formation of the part and/or label thus providing a label which is readable without being overly large; 2) provide notifications when a label may be difficult to read or interpret; and 3) are integrated at various stages of the manufacturing process so as parts are reoriented during packing into digital representation of an additive manufacturing bed, different label locations may be provided. However, it is contemplated that the devices disclosed herein may address other matters and deficiencies in a number of technical areas.

While specific reference is made to certain additive manufacturing processes such as multi-jet fusion or metal-jet fusion, the systems and methods may be applicable to any additive manufacturing process such as stereolithography, selective laser sintering, and fused deposition modeling, among others.

As used in the present specification and in the appended claims, the term “visual properties” refers to defining characteristics of a part including its geometry, dimensions, surface finishes, and material properties for example.

As used in the present specification and in the appended claims, the terms, “determiner,” “generator,” and “controller” refer to various hardware components, which may include a processor and memory. The processor may include the hardware architecture to retrieve executable code from the memory and execute the executable code. The memory may include a computer-readable storage medium, which computer-readable storage medium may contain, or store computer usable program code for use by or in connection with an instruction execution system, apparatus, or device. The memory may take many types of memory including volatile and non-volatile memory. For example, the memory may include Random Access Memory (RAM), Read Only Memory (ROM), optical memory disks, and magnetic disks, among others. As specific examples, the determiner, generator, and controller as described herein may include computer readable storage medium, computer readable storage medium and a processor, and an application specific integrated circuit (ASIC).

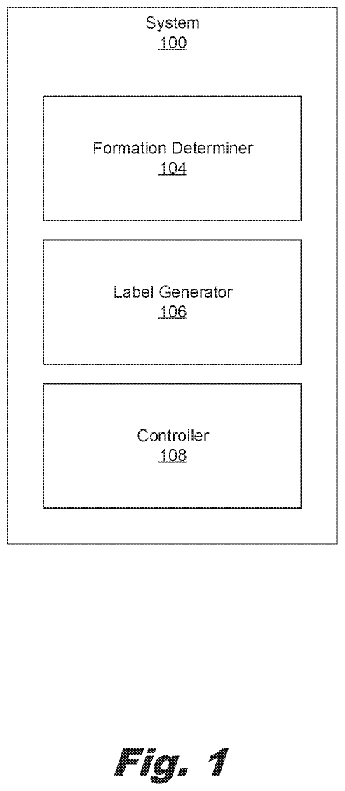

Turning now to the figures, FIG. 1 is a block diagram of a system (100) for selecting label properties based on part formation characteristics, according to an example of the principles described herein. As described above, product labels communicate a variety of information to different audiences. For example, a label may include an indication that a particular part satisfies certain quality metrics and may provide tracking information such that a particular source and/or batch associated with the product may be identified. Such information may also be used in servicing the product. For example, the label may include a model number or product specific ID to facilitate servicing of the product at a later point in time.

In another example, the label may include information used by a manufacturer. For example, during manufacture, the product may be subject to various manufacturing operations. These operations may be stored on the label and read by an employee who carries out the particular manufacturing operation.

In other words, the label which is affixed, or formed on a product may encode at least one of identification information for the part, identification information for a manufacturing device that forms the part, a batch number, and manufacturing instructions. While particular reference is made to certain types of information that may be encoded on the label, any variety of different types of information may be encoded on the label.

The label may take any variety of forms. For example, the label may include alphanumeric characters. Such alphanumeric characters may provide human readable information.

In another example, the label may be machine-readable, for example as a barcode, a two-dimensional matrix code, or other machine-readable pattern. In yet another example, the label may be designed for both human and machine readability, for example as an Optical Character Recognition (OCR) font. In yet another example, the label may be designed for visibility to machines, but not to humans, for example as a steganographic marking. While reference is made to a few particular types of label formats, the label may be of other types as well.

Accordingly, the present system (100) provides a label that is particularly tailored to the particular part on which it is placed. That is, the properties of the label are selected based on a number of criteria specifically relating to a particular part including when the label is to be read and the surface conditions at the time the label is to be read.

Accordingly, the system includes a formation determiner (104) determines characteristics of a formation of the part and a label to be disposed thereon. That is, the formation of the part bears on the readability of a label. For example, the readability of a label may change based on whether the surface on which it is disposed is horizontal or vertical in an additive manufacturing bed.

For example, assuming a cube-shaped product, when placed in a digital representation of an additive manufacturing bed, a first surface of the cube may be downward facing and a second surface may be side facing. In this example, due to manufacturing processes having different resolutions in the horizontal and vertical directions, an embossing or engraving on the downward facing surface may be more easily read as compared to an embossing or engraving on the side facing surface. Accordingly, a location of the part in an additive manufacturing bed where it is to be formed, and an orientation of the surface on which the label is to be formed may impact the selected label properties. As a specific example, if a label is to be formed on a surface that is downward facing, a smaller label and/or a smaller font may be used to form the label as compared to a label that is to be formed on a side facing surface.

Another example of a characteristic of the formation that is relied on in selecting label properties includes a location of the label on the part. For example, a label on an inner surface of a part which is to be viewed through an opening may justify a larger font and/or data matrix as compared to a label on an outer surface of the part.

Another example of a characteristic of the formation that is relied on in selecting label properties includes a stage of manufacturing at which the label is to be read. For example, during manufacturing, a 3D part may be printed and passed to a processing station. Before processing, the part may be the gray color of the fused build material with some remaining white unfused build material. Accordingly, if the label is to be read at this stage, due for example to the fact that it may include instructions regarding product processing, then the label may have a bigger font to account for the increased difficulty in printing readable text on the gray/white part. By comparison, if the label is to be read after a processing, when unfused powder from the printing operation has been removed, the font may be smaller or the data matrix may be smaller.

In yet another example, a characteristic of a formation that may be relied on is the surface finish of the location of the part where the label is to be placed. For example, in some cases, a part, or a portion of a part may be smoothed and/or dyed. The smoothing and dying may impact the readability of the label. For example, if the label is intended to be placed on a portion of the part that is to be dyed black, the label may be made smaller due in part to the increased ease of reading on a dyed surface. By comparison, if the label is intended to be placed on a portion of the part that is not to be dyed black, the label may be made larger to enhance its readability.

As yet another example, a part manufacturing constraint may be determined and used to select label properties. For example, as described above, an additive manufacturing system may print parts having a different resolution in one dimension than another. Accordingly, during generation of the part, a user may constrain the placement of the part to be in a particular orientation during printing. For example, if a hemisphere part is to be formed and it is desired that the base be as round as possible, a user may constrain the packing of the hemisphere into the digital representation of the additive manufacturing bed such that the round base benefits from the higher resolution. In this example, this manufacturing constraint may be used to select label properties such as label location, label font, size, color, etc. In other words, the formation determiner (104) determines these characteristics of formation and the label generator (106) then relies on this information to select label properties.

In some examples, the formation determiner (104) determines this information based on metadata associated with the part to be formed. That is, as described above, the visual properties of the part may be defined by a digital file and that digital file may include metadata describing such things as the location of the label, a stage of manufacturing at which the label is to be read, and a surface finish of the location of the part where the label is to be placed. Also, during packing, information may be received regarding the orientation of the part within a digital representation of the additive manufacturing bed etc. The formation determiner (104) acquires this information and passes it to the label generator (106).

The label generator (106) then selects label properties based on the visual properties of the part and the characteristics of the formation of the part and the label. That is, via simulation or experimentation, the system (100) can determine the appropriate label size based on the label style, the orientation of the surface to which the label will be formed, the printing process, and the time at which the label is to be read.

That is, as described above in some examples, the characteristics of the formation of a part and/or label impact the readability of the label and therefore affect the selection of particular label properties. For example, Table (1) below provides example minimum font sizes to engrave alphanumeric texts on different surfaces of a part.

TABLE 1

| Typeface | Top | Side | Bottom |
|---|---|---|---|
| Arial | B pt. | C pt. | C pt. |
| Helvetica | B pt. | C pt. | C pt. |
| OCR-A | B pt. | C pt. | C pt. |
| Times New | A pt. | B pt. | B pt. |
| Roman | | | |

In the example depicted in Table (1), A represents a font size that is bigger than font size B and font size C, and font size B represents a font size that is larger than font size C but smaller than font size A. Accordingly, in the example depicted in Table (1), smaller fonts may be used when the label is placed on a side or bottom surface as compared to a label placed on a top surface.

Table (2) below provides example minimum unit sizes to engrave a data matrix on different surfaces of a part.

TABLE 2

| Top | Side | Bottom |
|---|---|---|
| X mm × X mm | Y × Y mm | Y × Y mm |

In the example depicted in Table (2), X represents a length that is greater than Y. Accordingly, in the example depicted in Table (2), smaller data matrices may be used when the label is placed on a side or bottom surface as compared to a label placed on a top surface.

Similar tables may be generated based on the surface finish and when the label is to be read. For example, a label formed on the downward-facing surface of a 3D printed part printed with a certain polymer that is to be dyed black, and read after dying may have a minimum font size, D, and a minimum data matrix size, E. By comparison, a label formed on an upward-facing surface of a 3D printed part printed with the same polymer to be read immediately after processing but before dying may have a minimum font size, F, which is greater than D, and a minimum data matrix size of G which is greater than E.

Accordingly, as described above, the label generator (106) selects label properties based on the determined characteristics of the formation as well as the visual properties of the part. While particular reference is made to particular label properties that are selected, other properties may be selected as well. That is, the label generator (106) may select label properties such as size, font, form, type, and color of the label among others.

In addition to actively selecting certain label properties, the label generator (106) may restrict at least one label property based on at least one characteristic of the formation of the part and the label. For example, a certain size, or type of label may be precluded based on a location on which the label is to be placed.

In some examples, in addition to selecting label properties, the label generator (106) may generate a visual representation of the label. That is, as described above, a computing application may generate a visualization of the 3D part to be printed. In this example, the user interface may include controls to allow a user to select and place a label. During this stage, the label, along with the selected properties by the label generator (106), may be displayed on the part such that a user may visualize how the selected label will look once formed.

A controller (108) of the system (100) then controls formation of the label on the part. That is, after the label properties have been selected, and the parts have been modeled in a packing orientation within an additive manufacturing bed, the controller (108) controls the actual formation of the part and label. In the case of an additive manufacturing system, this may include controlling the sequential deposition of layers of a powdered build material and a fusing agent to in a layer-wise fashion generating the 3D printed part with the label disposed thereon.

Thus, the present system (100) allows for label customization that ensures readability while not overly impacting the aesthetics of the part to which it is attached. Such a system (100) allows the label to effectively communicate the valuable information disposed thereon in an effective and aesthetically pleasing fashion.

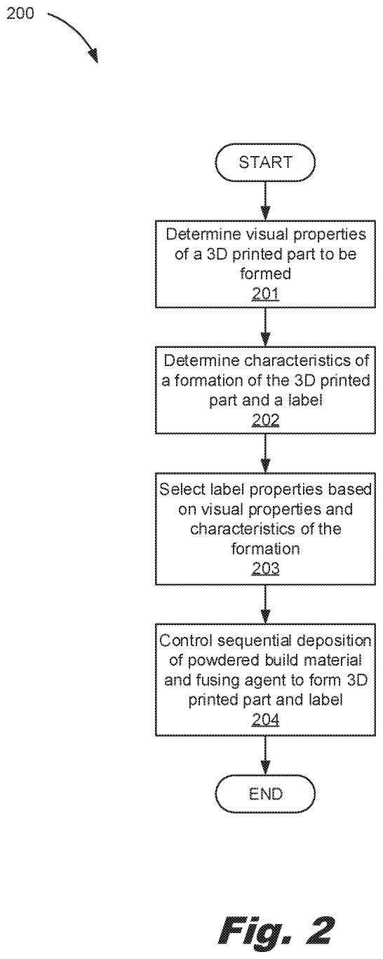

FIG. 2 is a flow chart of a method (200) for selecting label properties based on part formation characteristics, according to an example of the principles described herein. As described above, visual properties of a part, such as a 3D printed part, and the label which is formed on the part are determined (block 201). Characteristics of a formation of the 3D printed part and label are also determined (block 202). In some examples, this may be based on a file which is received. For example, a file may include metadata that describes part geometry, material properties, and any number of manufacturing operations.

In some examples, this information or a portion thereof, may be determined based on user feedback. That is, the system (FIG. 1, 100) may prompt a user to provide certain information. As a specific example, the system (FIG. 1, 100) may provide questions such as “what material will this part be made from?”, “will the label be read immediately after removal from the printer?”, and “will this part be dyed, polished, or left natural?”. Responses to these questions allows other system (FIG. 1, 100) components to determine label properties. While particular reference is made to a few ways to determine (block 201, 202) visual properties and characteristics of a formation of the 3D printed part and label, other ways may be possible as well.

As one particular example of determining (block 202) characteristics of the formation, a user via a user interface of a modeling application, may select a location for a label on a part. With visual properties determined (block 201) and this and other characteristics of formation determined (block 202), the system (FIG. 1, 100) may vary the minimum size possible for the label based on the surface orientation and the previously acquired information. For example, a minimum label size may be X mm×Y mm for a downward facing surface and A mm x B mm for an upward-facing surface, where A is greater than X and B is greater than Y. Accordingly, the present method (200) allows a user to select a location on a downward-facing surface that is at least X mm×Y mm while allowing the user to select locations on an upward-facing surface which are at least A mm by B mm in size. That is, as described above, the label generator (FIG. 1, 106), selects (block 203) label properties based on the visual properties of the 3D printed part and the characteristics of the formation of the 3D printed part and the label.

The controller (FIG. 1, 108) then controls the formation of the 3D printed part and the label. Specifically, in the case of an additive manufacturing system using a powdered build material and a fusing agent, the controller (FIG. 1, 108) may control (block 204) the sequential deposition of powdered build material and a fusing agent that form the 3D printed part and the label. That is, the surface on which the label is to be formed may be either removed (in the case of engraving), be added to (in the case of embossing), changed color, or otherwise altered to form the part as well as the label that is to be formed thereon.

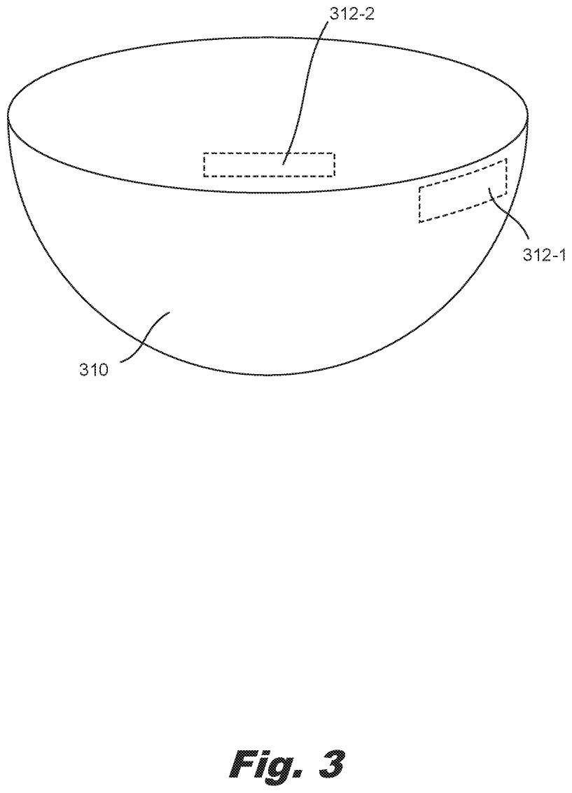

FIG. 3 is a diagram of a modeling stage during which label (312) properties are selected, according to an example of the principles described herein. In the example depicted in FIG. 3, the part (310) to be formed is a 3D hemisphere. FIG. 3 also depicts various candidate label (312) locations.

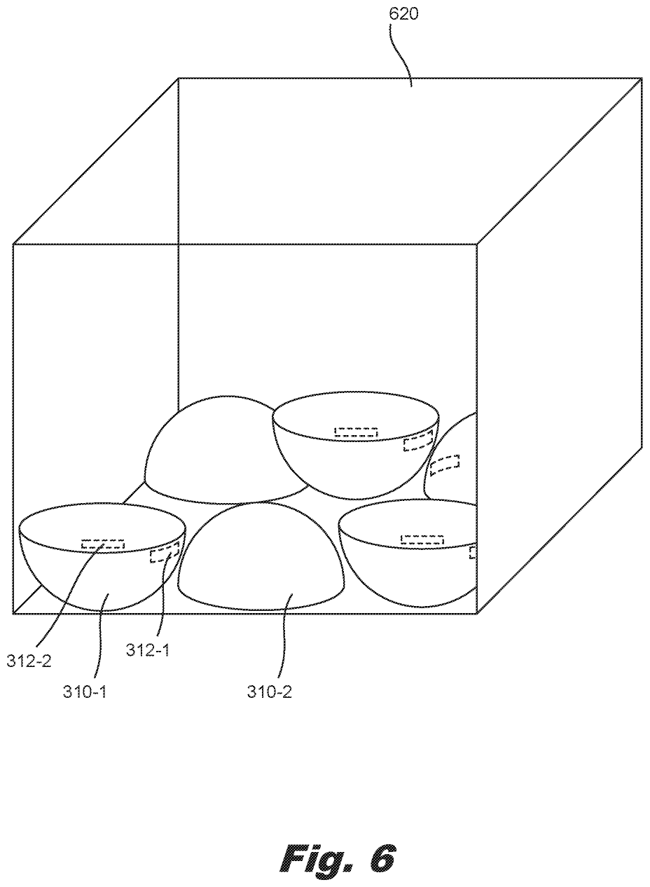

As described above, in some examples, the visual properties may be modeled. That is, a computer application may be run to generate a 3D model of the part to be printed. The selection of the label (312) properties may occur in such a modeling stage. As will be described below, additional properties may be selected, or properties may be adjusted, in a packing stage depicted in FIG. 6. In addition to displaying the product (310), the system (FIG. 1, 100) may also display the label (312) with the selected characteristics.

In some examples, the label generator (FIG. 1, 106) may generate multiple candidate labels (312-1, 312-2) with different label properties. For example, the system (FIG. 1, 100) may place a first label (312-1) at a particular location and may place a second label (312-2) at a different location. Each of these labels (312) may have different properties. For example, the first label (312-1) may have certain properties based on its location on a side of the part (310) that are different from the properties for the second label (312-2) based on its location on a top surface of the part (310).

In some examples, placement of the labels (312) may be based on user input. That is, within the computing application that generates the visual representation of the part (310), a tool may allow a user to position a label (312) in a particular position. Based on the information determined by the formation determiner (FIG. 1, 104), the system (FIG. 1, 100) may perform a number of operations responsive to such a placement. For example, if the location is permissible, i.e., it would result in a label (312) with properties that are not prevented and that is readable, then a notification may be provided to the user that such a label would be acceptable.

By comparison, the system (FIG. 1, 100) may indicate that a selected location for the label is not permissible based on predetermined criteria. For example, the metadata associated with a part may indicate that no labels should be provided on a rounded surface of the hemisphere. Accordingly, if a user attempts to place the first label (312-1) on the part (310), the user may be notified that this selected location is not permissible based on part (310) data. By comparison, if a user attempts to place the second label (312-2) on the part (310), the user may be allowed to do so. In the case that due to conflicting predetermined conditions, no suitable location exists, the system (FIG. 1, 100) may notify the user of such.

In summary, the system (FIG. 1, 100) can aid the user in selecting label locations, by showing them the proposed label size for different surface orientations. Accordingly, the system (FIG. 1, 100) can store different label styles and sizes for different part (310) orientations. Appropriate label styles and sizes can then be applied when engraving the label (312) onto the part, just before printing.

From the multiple candidate labels (312), the system (FIG. 1, 100) can perform a variety of actions. First, the system can make a recommendation to a user of one of the candidate labels (312). In this example, selection of the final label (312) is done via user input. In another example, the system (FIG. 1, 100) may automatically select one of the candidate labels (312) for formation on the 3D printed part (310). That is, if there are several possible label (312) locations, the system (FIG. 1, 100) can recommend, or select, the label style which will provide the best readability and/or the smallest label size.

Note that in some examples, selection of label (312) properties may occur at a different stage from selecting information to be encoded on the label (312). For example, if a label is to include a part identification number, for security reasons and to ensure a unique part identification number, the actual number may be selected just prior to printing and following the modeling stage, during which modeling stage the location and properties of the label (312) are selected. That is, during the modeling stage, a location and font for a textual label (312) may be determined, but the actual text, i.e., the unique identifier, may not be placed until just before printing. Doing so provides security to the use of the identifier as it is less likely to be replicated later on in the manufacturing process.

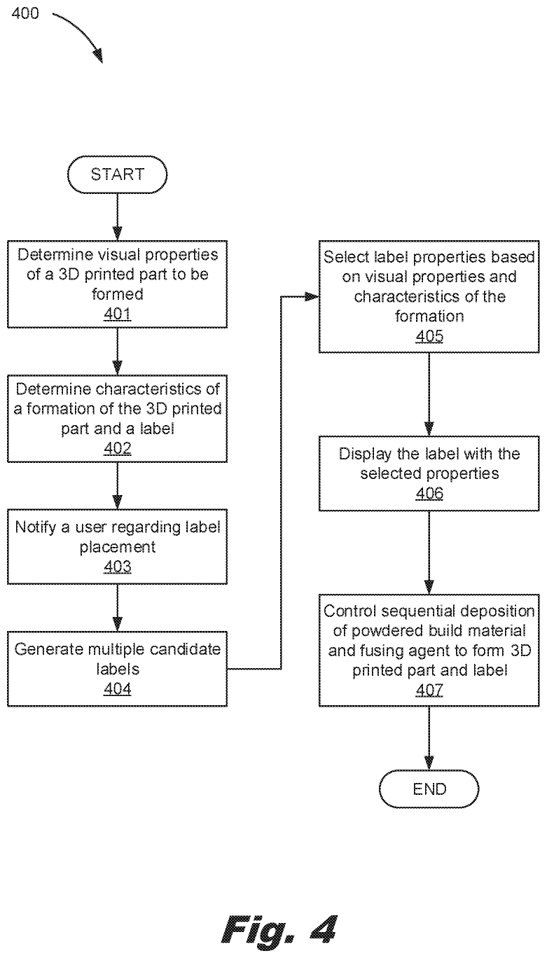

FIG. 4 is a flow chart of a method (400) for selecting label (FIG. 3, 312) properties based on part (FIG. 3, 310) formation characteristics, according to another example of the principles described herein. According to the method (400), visual properties of the 3D printed part (FIG. 3, 310) as well as characteristics of a formation of the 3D printed part (FIG. 3, 310) are determined (block 401, 402). These operations may be performed as described in connection with FIG. 2.

In some examples, a notification is provided (block 403) to a user relating to the permissibility of a label (FIG. 3, 312) and more specifically regarding the permissibility of a label (FIG. 3, 312) at a particular location. For example, as described above, a user may be notified (block 403) that a label (FIG. 3, 312) location is acceptable, unacceptable, or that no acceptable location exists based on the part (FIG. 3, 310) geometry. That is, the part (FIG. 3, 310) may be too small such that the minimum font size or other size threshold for a particular label (FIG. 3, 312) is not met. In this situation, a user may alter the 3D printed part (FIG. 3, 310) so that the label (FIG. 3, 312) may be properly placed.

Also as described above, the system (FIG. 1, 100) may generate (block 404) multiple candidate labels (FIG. 3, 312) each with unique label (FIG. 3, 312) properties. These candidate labels (FIG. 3, 312) may be generated automatically or based on user input.

The system, either relying on user input or automatically, may then perform any number of operations such as making a recommendation to a user of one of the candidate labels (FIG. 3, 312) or automatically selecting one of the candidate labels (FIG. 3, 312) for formation on the 3D printed part (FIG. 3, 310). That is, the system (FIG. 1, 100) may select (block 405) label properties and in some examples display (block 406) the label (FIG. 3, 312) with the selected properties, for example in a computer aided modeling application. The controller (FIG. 1, 108) may then control (block 407) the sequential deposition of powdered build material and fusing agent to form the 3D printed part (FIG. 3, 310) and label (FIG. 3, 312) as described above in connection with FIG. 2.

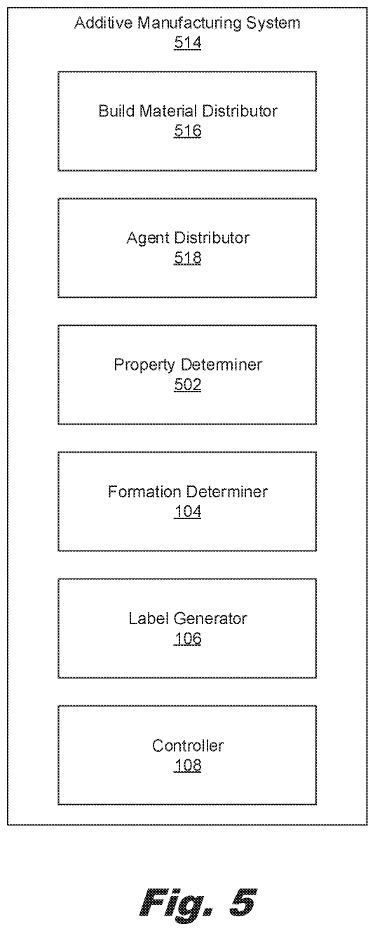

FIG. 5 is a block diagram of an additive manufacturing system (514) for selecting label (FIG. 3, 312) properties based on part (FIG. 3, 310) formation characteristics, according to another example of the principles described herein. In general, apparatuses for generating three-dimensional part (FIG. 3, 310) may be referred to as additive manufacturing systems (514). The additive manufacturing system (514) described herein may correspond to three-dimensional printing systems, which may also be referred to as three-dimensional printers.

The additive manufacturing system (514) includes a build material distributor (516) to successively deposit layers of the build material onto a bed. In some examples, the build material distributor (516) may be coupled to a scanning carriage. In operation, the build material distributor (516) places build material on the bed as the scanning carriage moves over the bed. The build material distributor (516) may include a wiper blade, a roller, and/or a spray mechanism.

The additive manufacturing system (514) includes an agent distributor (518) to selectively distribute a fusing agent onto layers of the powdered build material to selectively solidify portions of a layer of building material to form a 3D printed part (FIG. 3, 310) and the label formed thereon. In some examples, the agent distributor (518) is coupled to a scanning carriage that moves along a scanning axis over the bed.

An agent distributor (518) may be a liquid ejection device. A liquid ejection device may include at least one printhead (e.g., a thermal ejection based printhead, a piezoelectric ejection based printhead, etc.). In one example, printheads that are used in inkjet printing devices may be used as an agent distributor (518). In this example, the fusing agent may be a printing liquid. In other examples, an agent distributor (518) may include other types of liquid ejection devices that selectively eject small volumes of liquid.

The additive manufacturing system (514) may include other components such as a heater to selectively fuse portions of the build material to form an object (FIG. 3, 310) via the application of energy to the build material. The heater may be a component that applies energy such as infrared lamps, visible halogen lamps, resistive heaters, light emitting diodes LEDs, and lasers. The heater may apply an amount of energy such that those portions with an increased absorption rate (due to the presence of fusing agent) reach a temperature greater than the fusing temperature while those portions that do not have the increased absorption rate to not reach a temperature greater than the fusing temperature.

The additive manufacturing system (514) also includes a property determiner (502) to determine visual properties of the part to be formed. That is, the property determiner (502) acquires information regarding various aspects of the appearance of a product including its dimensions, material properties, and other features. While specific reference is made to a few specific properties, any variety of visual property of a part to be formed may be acquired.

In some examples, the visual properties may be displayed on a user interface. For example, a digital model of a 3D printed part may be generated and displayed within a computer-aided drafting application on a computing device. Through this user interface, the digital representation of the part may be manipulated and created.

The additive manufacturing system (514) also includes a formation determiner (104), label generator (106), and controller (108) as described above.

FIG. 6 is a diagram of a packing stage during which label (312) properties are selected, according to an example of the principles described herein. As described above, label (312) properties may be determined, or adjusted, once a part (310) enters a packing stage. During a packing stage, digital representations of multiple parts (310) are laid out in a digital representation of an additive manufacturing bed (620). This layout defines the orientation of the parts (310) during physical printing. In FIG. 6, a front face of the additive manufacturing bed (620) has been removed to illustrate the parts (310) inside. For simplicity, just two instances of a part (310) and two instances of labels (312-1, 312-2) are depicted with reference numbers.

As described above, some of the characteristics of formation that are relied on in selecting label (312) properties include a position and orientation of a part (310) within an additive manufacturing bed (620). For example, it may be the case that downward facing surfaces will be printed with a different surface finish as compared to angled surfaces based on operation of the additive manufacturing system (FIG. 5, 514). For example, on a first part (310-1), the rounded portion may have a different surface finish as compared to a top flat portion. Accordingly, in this example, label (312) properties may be selected such that the label (312) will be formed on a surface that would result in best readability of the label (312).

To more effectively pack parts (310) into a bed (620), different parts (310) may be oriented differently. For example, the first part (310-1) may have a rounded surface facing down and a second part (310-2) may have a flat surface facing down. Based on the packing of parts (310) into the additive manufacturing bed (620), any number of operations may be carried out.

As a first example, the label (312) position on each part (310) may be different. For example, the first label (312-1) may be formed on the first part (310-1) and a label on the second part (310-2) may be positioned on the flat surface such that labels (312) for each part (310) are formed on different surfaces. As described above, because these labels (312) are formed on different surfaces, they may have different properties. That is, the different labels may have different sizes based on the different orientations within the additive manufacturing bed (620).

As with the modeling stage, in some examples, a notification regarding the placement of the label (312) may be made. For example, if metadata relating to the part (310) indicates that no label (312) may be placed on the rounded portion, a notification may be provided to the user that the first label (312-1) is not an acceptable option. That is, in these examples, if a user re-orients a part (310) while packing a build, the system (FIG. 1, 100) can select from among possible label (310) locations, or may warn the user that no suitable location exists.

As described above, one characteristic of a formation of a part (310) that is relied on when determining label (312) properties is part (310) constraints. For example, it may be that metadata relating to a part (310) prevents certain orientations within an additive manufacturing bed (620). Accordingly, in this example, label (312) selection may be based, at least in part on these restrictions. As a specific example, due to accuracy concerns, a part (310) reorientation may be constrained to rotations of 90 degrees about a vertical access and flipping the part (310) upside down. Accordingly, label (312) placement may also be restricted to be rotated about a vertical axis so long as the label (312) side is facing down. In other words, the label (312) placement may be selected based on constraints on the rotation of the part (310) as well as the label (312) position.

As described above, in some examples label (312) placement, or other label (312) properties, may be constrained by predetermined criteria. For example, if the user attempts to place a label (312) in a specific orientation which would make the label (312) unreadable, then the system (FIG. 1, 100) can warn the user and/or prevent the re-orientation. Therefore, during printing, the system (FIG. 1, 100) can select from among the best possible label (312) locations and styles, and select the combination with the smallest label size or best readability.

In some examples, the controller (FIG. 1, 108) may restrict certain part (310) re-orientations during a packing stage based on the label (312) readability. For example, based on the label (312) size and surface orientation, the system (FIG. 1, 100) can limit the permissible part orientations during packing to those where the label (312) would still be readable.

The present systems and methods 1) automatically vary the label properties based on characteristics of the formation of the part and/or label thus providing a label which is readable without being overly large; 2) provide notifications when a label may be difficult to read or interpret; and 3) are integrated at various stages of the manufacturing process so as parts are reoriented during packing into digital representation of an additive manufacturing bed, different label locations may be provided. However, it is contemplated that the devices disclosed herein may address other matters and deficiencies in a number of technical areas.

What is claimed is:

1. A system, comprising:
a formation determiner to determine characteristics of a formation of the part and a label to be disposed thereon;
a label generator to select label properties based on visual properties of the part and the characteristics of the formation of the part and label; and
a controller to control formation of the label on the part.

2. The system of claim 1, further comprising a property determiner to determine visual properties of a part to be formed.

3. The system of claim 1, wherein the label properties comprise at least one of a size, font, form, type, and color of the label.

4. The system of claim 1, wherein the characteristics of the formation of the part and the label comprise at least one of:
a location of the label on the part;
an orientation of the surface on which the label is to be formed;
a stage of manufacturing at which the label is to be read;
a surface finish of the surface on which the label is to be formed;
a location of the part in an additive manufacturing bed where it is to be formed
an orientation of the part in an additive manufacturing bed where it is to be formed; and
a part manufacturing constraint.

5. The system of claim 1, wherein the label generator restricts at least one label property based on at least one characteristic of the formation of the part and the label.

6. The system of claim 1, wherein the label comprises at least one of:
human-readable markings;
machine-readable-markings;
markings which are both machine-readable and human-readable; and
markings which are machine-readable but not visible to humans.

7. A method, comprising:
determining visual properties of a three-dimensional (3D) printed part to be formed;
determining characteristics of a formation of the 3D printed part and a label to be disposed thereon;
selecting label properties based on the visual properties of the 3D printed part and the characteristics of the formation of the 3D printed part and the label; and
controlling sequential deposition of powdered build material and a fusing agent to form the 3D printed part and the label.

8. The method of claim 7, wherein selection of label properties occurs during at least one of:
a modeling stage; and
a packing stage wherein the 3D printed part is laid out in a digital representation of an additive manufacturing bed.

9. The method of claim 7, further comprising notifying a user that at least one of:
a permissible location for the label on the 3D printed part does not exist based on predetermined criteria; and
a selected location for the label is not permissible based on the predetermined criteria.

10. The method of claim 7, further comprising:
generating multiple candidate labels with different label properties; and
performing at least one of:
making a recommendation to a user of one of the candidate labels; and
selecting one of the candidate labels for formation on the 3D printed part.

11. The method of claim 7, further comprising displaying the label with the selected characteristics.

12. An additive manufacturing system, comprising:
a build material distributor to deposit layers of powdered build material onto a bed;
an agent distributor to selectively solidify portions of layers of powdered build material to form a three-dimensional (3D) printed object and a label formed thereon;
a property determiner to determine visual properties of a part to be formed;
a formation determiner to determine characteristics of the formation of the part and a label to be disposed thereon;
a label generator to select label properties based on the visual properties of the part and the characteristics of the formation of the part and label; and
a controller to control formation of the label on the part.

13. The additive manufacturing system of claim 12, wherein the label is embossed or engraved on the 3D printed part.

14. The additive manufacturing system of claim 12, wherein selecting label properties occurs at a different stage from selecting information to encode in the label.

15. The additive manufacturing system of claim 12, wherein the controller restricts part re-orientation during a packing stage based on label readability.
